(19) United States
(12) Patent Application Publication
(10) Pub. No.: US 2023/0227755 A1
(43) Pub. Date: Jul. 20, 2023

(54) NON-FLUOROCARBON LAUNDRY TREATMENT PROVIDING ENHANCED FLUID REPELLENCY

(71) Applicant: ECOLAB USA INC., Saint Paul, MN (US)

(72) Inventors: Kaustav Ghosh, Saint Paul, MN (US); David Dotzauer, Saint Paul, MN (US); Benjamin Oanes, Saint Paul, MN (US); Meaghan Martin, Saint Paul, MN (US)

(21) Appl. No.: 18/156,473

(22) Filed: Jan. 19, 2023

Related U.S. Application Data
(60) Provisional application No. 63/266,931, filed on Jan. 19, 2022.

(51) Int. Cl. C11D 3/00; C11D 11/00; C11D 3/37; C11D 3/18; C11D 3/43; D06L 1/22; D06M 15/564; D06M 15/643; D06M 13/224; D06M 13/02

(52) U.S. Cl. CPC C11D 3/0036; C11D 11/0058; C11D 11/0017; C11D 3/3726; C11D 3/181; C11D 3/373; C11D 3/43; D06L 1/22; D06M 15/564; D06M 15/643; D06M 13/224; D06M 13/02; D06M 2200/12; D06M 2101/06

(57) ABSTRACT

Non-fluorocarbon compositions for providing enhanced fluid repellency on various surfaces, including for laundry treatments in a finishing step of a laundry process, are disclosed. Non-fluorocarbon laundry treatment compositions and compositions including the non-fluorocarbon chemistries and a substrate surface are also disclosed along with methods of using the same in a laundry application.

### CROSS-REFERENCE TO RELATED APPLICATION

This application claims priority under 35 U.S.C. § 119 to Provisional Application U.S. Ser. No. 63/266,931, filed on Jan. 19, 2022, which is herein incorporated by reference in its entirety including without limitation, the specification, claims, and abstract, as well as any figures, tables, or examples thereof.

### TECHNICAL FIELD

The disclosure relates to use of non-fluorocarbon treatment compositions for providing enhanced fluid repellency on various surfaces, including for laundry treatments in a finishing step of a laundry process. Non-fluorocarbon laundry treatment compositions and compositions including the non-fluorocarbon chemistries and a substrate surface are also provided. The non-fluorocarbon treatment compositions improve and/or maintain fluid repellancy on a treated substrate surface without the use of fluorocarbons or fluorinated chemistries.

### BACKGROUND

Fluorinated copolymers provide good repellency to fluid. Various industrial applications and products use fluorinated compounds (including PFAS-containing (perfluoroalkyl substances), most commonly PFOA (perfluorooctyl acid) to impart water repellent and water repellent coatings on textiles surfaces. For example, for health and safety reasons hospital and medical gowns, surgical drapes, and the like are treated with fluorinated compounds to provide repellency to minimize exposure to blood and bodily fluids. The are many other surfaces treated with fluorinated compounds to provide water repellency and water repellency. However, the use of such fluorinated compounds presents health, safety and environmental concerns and limitations.

Many of these treated textiles surfaces are afforded their fluid resistant protective coatings or barriers at a textile mill, where they are most often applied to bolt cloth prior to cutting and sewing. Conventional application of barrier treatment chemistries may be applied via a padding or spray-on process that also cures the chemistry onto the textile surface through use of high-heat.

Certain fluorinated compounds and barrier treatments are known to wear off over time through normal use and washing of the substrate surfaces. Traditional laundering processes recognize this and often include a finishing step to impart a barrier or repellency onto the textile. In some traditional cleaning systems or methods, the washing process includes a pre-wash or pre-soak where the textiles are wetted, and a pre-soak composition is added. The wash phase follows the pre-soak phase; a detergent composition is added to the wash tank to facilitate soil removal. In some cases, a bleach phase follows the wash phase in order to remove oxidizable stains and whiten the textiles. Next, the rinsing phase removes all suspended soils. In some cases, a laundry sour is added in a souring or finishing phase to neutralize any residual alkalinity from the detergent composition. In many cases a fabric softener or other finishing chemical—such as a fluoropolymer to provide water repellancy—is also added in the finishing step. Finally, the extraction phase removes as much water from the wash tank and textiles as possible. In some cases, more than one wash cycle, rinse and/or extraction phases can be included. After the wash cycle is complete, the resulting wastewater is typically removed and discarded. The chemistries used in the washing cycle are then discarded into the wastewater stream.

It is undesirable to allow fluorinated compounds to enter the wastewater streams. Many regions, states or countries have taken environmental positions that intent to limit or prevent any release of PFAS into the environment and therefore are directing the phasing out of the use of PFAS in industrial and institutional applications. Although not all PFAS-containing components are easily worn off over time as other repellency and barrier treatments, there are health, safety and environmental concerns with these materials and strong movement towards eliminating their use.

Accordingly, there is a need to reduce or remove the use of PFAS-containing materials from products, namely from those that are laundered and result in the fluorinated compounds entering water sources or water supply.

Thus, there exists a need in the art for removing use of fluorinated chemistries from laundry treatments while providing non-fluorocarbon laundry treatment compositions that provide fluid repellency.

It is therefore an object of this disclosure to provide a non-fluorocarbon laundry treatment composition in the final rinse of a laundry process to provide at least equivalent fluid repellency on textiles as fluorinated laundry chemistries.

It is a further object of this disclosure to provide a non-fluorocarbon laundry treatment composition in the final rinse of a laundry process to provide enhanced fluid repellency on textiles.

It is a further object of the disclosure to barrier treatments through use of the non-fluorocarbon treatment composition in various other applications in addition to textiles in a laundry process to provide enhanced fluid repellency on other surfaces.

It is another object of this disclosure to formulate non-fluorocarbon treatment compositions to deposit a barrier on the substrate surface, such as a textile surface, to provide a barrier for more than one wash cycle, wherein repeated wash cycles provide additional barrier onto the surface to maintain the effective fluid repellency.

Other objects, embodiments and advantages of this invention will be apparent to one skilled in the art in view of the following disclosure, the drawings, and the appended claims.

### BRIEF SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present application to improve on or overcome the deficiencies in the art, namely the use of fluorinated chemistries in laundry applications and for barrier treatments for substrates.

In embodiments a method of using a non-fluorocarbon treatment composition to impart fluid repellency to a substrate comprises: applying a non-fluorocarbon treatment composition to a substrate in a finishing step of a washing cycle for textile substrates, wherein the non-fluorocarbon treatment composition comprises: a non-fluorocarbon treatment component comprising at least one of a paraffin-based hydrophobic agent, a polydimethylsiloxane, or urethane-based hydrophobic agent; a nonionic surfactant deposition aid; and water; wherein the non-fluorocarbon treatment composition is an aqueous dispersion or emulsion; and imparting fluid repellency to the substrate.

In embodiments a non-fluorocarbon treatment composition comprises: a non-fluorocarbon treatment component comprising at least one of a paraffin-based hydrophobic agent, a polydimethylsiloxane, or urethane-based hydrophobic agent; a nonionic surfactant deposition aid, and water, wherein the composition is an aqueous dispersion or emulsion.

In embodiments a treated substrate comprises a substrate and a non-fluorocarbon treatment composition as described herein deposited thereon the substrate, wherein the treated substrate is a fluid repellent surface, and wherein the substrate is a synthetic substrate or a cellulosic material.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### DETAILED DESCRIPTION OF THE INVENTION

The present disclosure is not to be limited to that described herein, which can vary and are understood by skilled artisans. No features shown or described are essential to permit basic operation of the present invention unless otherwise indicated. It has been surprisingly found that the combined use of a non-fluorocarbon composition in a finishing step of laundry provides at least substantially-similar or improved fluid repellency on a fabric surface to that treated with a fluorocarbon-containing composition.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

The terms “invention” or “present invention” are not intended to refer to any single embodiment of the particular invention but encompass all possible embodiments as described in the specification and the claims.

Unless defined otherwise, all technical and scientific terms used above have the same meaning as commonly understood by one of ordinary skill in the art to which embodiments of the present invention pertain.

The term “about,” as used herein, refers to variation in the numerical quantity that can occur, for example, through typical measuring techniques and equipment, with respect to any quantifiable variable, including, but not limited to, mass, volume, time, temperature, pH, and log count of bacteria or viruses. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups. In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “aqueous repellency” or “repellency” with respect to textiles and soft surfaces refers to the characteristic of the textile or soft surface whereby it resists wetting by aqueous liquids.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “detergent composition” includes, unless otherwise indicated, detergent compositions, laundry detergent compositions, and detergent compositions generally. Detergent compositions can include both solid, pellet or tablet, paste, gel, and liquid use formulations. The detergent compositions include laundry detergent cleaning agents, bleaching agents, sanitizing agents, laundry soak or spray treatments, fabric treatment or softening compositions, pH adjusting agents, and other similar detergent compositions.

As used herein, the term “exemplary” refers to an example, an instance, or an illustration, and does not indicate a most preferred embodiment unless otherwise stated.

As used herein, the term “fluid repellency” refers to properties of a treated surface with the non-fluorocarbon treatment compositions described herein to resist wetting with fluids, including water, solvents, and oils. The degree of repellency can vary based on the particular fluid and can be reported according to various grades, such as described in AATCC 118 and AATCC 193.

As used herein, the term “free” refers to compositions completely lacking the component or having such a small amount of the component that the component does not affect the performance of the composition.

The term “generally” encompasses both “about” and “substantially.”

The term “laundry” refers to items or articles that are cleaned in a laundry washing machine. In general, laundry refers to any item or article made from or including textile materials, woven fabrics, non-woven fabrics, and knitted fabrics. The textile materials can include natural or synthetic fibers such as silk fibers, linen fibers, cotton fibers, polyester fibers, polyamide fibers such as nylon, acrylic fibers, acetate fibers, and blends thereof including cotton and polyester blends (e.g. 80/20 polyester/cotton blends; 65/35 polyester/cotton blends; and 55/45 cotton/polyester blends). The fibers can be treated or untreated. Exemplary treated fibers include those treated for flame retardancy. It should be understood that the term “linen” is often used to describe certain types of laundry items including bed sheets, pillow cases, towels, table linen, table cloth, bar mops and uniforms.

As used herein, the term “soft surface” refers to surfaces not classified as hard surfaces, but which are solid surfaces. Soft surfaces, include, but are not limited to, textiles, fabrics, woven surfaces, and non-woven surfaces. Soft surfaces, include, but are not limited to, carpet, curtains, fabrics, hospital partitions, linens, and upholstery.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “substantially similar repellency” refers generally to achievement by the non-fluorocarbon treatment composition of a repellency grade that is of generally the same degree (or at least not a significantly lesser degree) of aqueous repellency in comparison to the repellency provided by a fluorinated composition on the same substrate.

The term “surfactant” or “surface active agent” refers to an organic chemical that when added to a liquid changes the properties of that liquid at a surface.

As used herein, the term “textile” refers to both unprocessed and processed fibers, strands, yarns, woven or knit fabrics, non-woven fabrics, garments, linens, laundry articles, and the like. Textiles may be re-usable or disposable.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end user can dilute the concentrate with water or an aqueous diluent to a use solution.

As used herein, the term “wash water” “wash water source,” “wash liquor,” “wash water solution,” and the like, as used herein, refer to water sources that have been contaminated with soils from a cleaning application and can be used in circulating and/or recirculating water containing detergents or other cleaning agents used in cleaning applications. Alternatively, wash water can be regularly discarded and replaced with clean water for use as wash water in cleaning applications. For example, certain regulations require wash water to be replaced after a set number of hours to maintain sufficiently clean water sources for cleaning applications. Wash water, according to the application, is not limited according to the source of water. Exemplary water sources suitable for use as a wash water source include, but are not limited to, water from a municipal water source, or private water system, e.g., a public water supply or a well, or any water source containing some hardness ions.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Treatment Compositions

According to embodiments, the non-fluorocarbon treatment compositions include an aqueous dispersion or emulsion of a non-fluorocarbon treatment component with a deposition aid to provide an effective barrier for fluid repellency on a surface, including depositing on a surface, such as a textile, to remain on the surface until a subsequent wash cycle. In embodiments the non-fluorocarbon treatment components can include a paraffin-based hydrophobic agent, polydimethylsiloxanes, and/or urethane-based hydrophobic agents. The non-fluorocarbon treatment compositions can include additional functional ingredients suitable for a finishing step in laundry or treating other substrate surfaces and can be provided as concentrate or use compositions (with laundry applications conventionally applied as a concentrate as they are not applied directly to the textile, instead diluted in the wash process). Exemplary concentrate non-fluorocarbon treatment compositions are shown in Table 1 in weight percentage.

While the components may have a percent actives of 100%, it is noted that Table 1 does not recite the percent actives of the components, but rather, recites the total weight percentage of the raw materials (i.e. active concentration plus inert ingredients).

TABLE 1

| | First Exemplary | Second Exemplary | Third Exemplary |
|---|---|---|---|
| Material | Range wt.-% | Range wt.-% | Range wt.-% |
| Non-fluorocarbon | 5-70 | 10-60 | 20-50 |
| treatment component | | | |
| Deposition aid | 0.1-20 | 1-10 | 1-7 |
| Additional Functional | 0-40 | 0.1-20 | 1-10 |
| Ingredients | | | |
| Water | Remainder | Remainder | Remainder |

The concentrated liquid compositions of Table 1 are diluted to form use compositions, as well as ready-to-use compositions. In general, a concentrate refers to a composition that is intended to be diluted with water to provide a use solution that contacts an object to provide the desired cleaning, rinsing, or the like. The composition that contacts the substrates to provide fluid repellency can be referred to as a concentrate or a use composition (or use solution) dependent upon the formulation employed in methods. It should be understood that the concentration of the non-fluorocarbon treatment component and other components will vary depending on whether the cleaning composition is provided as a concentrate or as a use solution.

A use solution may be prepared from the concentrate by diluting the concentrate with water at a dilution ratio that provides a use solution having desired detersive properties. The water that is used to dilute the concentrate to form the use composition can be referred to as water of dilution or a diluent and can vary from one location to another. The typical dilution factor is between approximately 1 and approximately 10,000 but will depend on factors including water hardness, the amount of soil to be removed and the like. In an embodiment, the concentrate is diluted at a ratio of between about 1:10 and about 1:10,000 concentrate to water, inclusive of all integers with this range, e.g., 1:50, 1:100, 1:1,000, and the like. Particularly, the concentrate is diluted at a ratio of between about 1:100 and about 1:5,000 concentrate to water.

In embodiments the non-fluorocarbon treatment compositions include the non-fluorocarbon treatment component and deposition aid to provide the hydrophobic properties to the treated substrate. Beneficially the methods do not require (and the compositions can be free of) any polyacrylates, isocyanates, melamine resins, polymeric silicic acids including elementary metals or metal oxides, or other hydrophobic components.

### Non-Fluorocarbon Treatment Component

The non-fluorocarbon treatment compositions comprises at least one non-fluorocarbon treatment component. Exemplary non-fluorocarbon treatment components include paraffin-based hydrophobic agents, polydimethylsiloxanes, and urethane-based hydrophobic agents. Each of the non-fluorocarbon treatment components provide improved fluid repellency on a treated substrate surface in comparison to an untreated substrate surface, such as a synthetic textile or cellulosic material. Further the non-fluorocarbon treatment components in combination with the deposition aid provide further improved repellent properties.

In some embodiments, the non-fluorocarbon treatment component is included in the composition at an amount of at least about 5 wt-%, at least about 10 wt-% to about 70 wt-%, about 10 wt-% to about 60 wt-%, about 10 wt-% to about 50 wt-%, about 15 wt-% to about 50 wt-%, about 20 wt-% to about 50 wt-%, or about 30 wt-% to about 50 wt-%. In addition, without being limited according to the invention, all ranges recited are inclusive of the numbers defining the range and include each integer within the defined range.

In some embodiments, the non-fluorocarbon treatment component is included in the composition at an amount of at least about 3% actives, between about 5% actives to about 20% actives, or between about 5% actives to about 15% actives. In addition, without being limited according to the invention, all ranges recited are inclusive of the numbers defining the range and include each integer within the defined range.

### Paraffin-Based Hydrophobic Agents

The paraffin-based hydrophobic agent includes a paraffin and polymer dispersion, including those available under the tradename Arkophob FFR, Arkophob 2168, and Evo Protect DFP. These components can include dispersion of fat-modified compounds and paraffins, which are also understood to be dispersions of paraffin waxes.

Exemplary paraffin waxes comprise or consist of n-paraffins in an amount of from 75 to 95% by weight and isoparaffins, and/or cycloparaffins and/or aromatic compounds in an amount of from 5 to 25% by weight, based on the total amount of the wax (=100% by weight), wherein the n-paraffins have from 20 to 60 carbon atoms, preferably wherein the n-paraffins have a molecular weight of from 300 to 600. The molecular weight can be determined with gel-permeation chromatography and the distribution of n-paraffins, isoparaffins, cycloparaffins and aromatic compounds may be determined using 13C NMR spectroscopy. Additional description of exemplary paraffin and polymer dispersions is set forth in U.S. Pat. Nos. 11,072,885 and 10,597,816, which is herein incorporated by reference in its entirety. Preferably paraffin-based hydrophobic agent has a melting point between about 50-100° C.

Additional waxes can optionally be used in the compositions instead of or in addition to the paraffin-based waxes, including for example, natural waxes (e.g. vegetable waxes, animal waxes such as bees wax, mineral waxes, petrochemical waxes), chemically modified waxes, or synthetic waxes (e.g. waxes based on polyalkylene and polyethylene glycol) that provide the desired hydrophobic properties.

### Polydimethylsiloxanes

The polydimethylsiloxane that can be included as a non-fluorocarbon component can be a silicone according to the general formula:

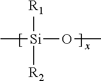

wherein, each R₁ and R₂ in each repeating unit, —(Si(R₁)(R₂)O)—, are independently selected from a C₁-C₁₀ alkyl or alkenyl radicals, phenyl, substituted alkyl, substituted phenyl, or units of -[—R₁R₂Si—O—]-; x is a number from 50 to 300,000, preferably from 100 to 100,000, more preferably from 200 to 50,000, wherein, the substituted alkyl or substituted phenyl are typically substituted with halogen, hydroxyl groups, polyalkoxy groups, carboxyl groups, or nitro groups, and wherein the silicone polymer is terminated by a hydroxyl group, hydrogen or —SiR₃, wherein, R₃ is hydroxyl, hydrogen, methyl or a functional group. A polydimethylsiloxane does not have any amino functionality in the silicone polymers. A commercially available polydimethylsiloxane is available under the tradename Wacker Liosil® HC and is available in various functionalized silicone fluid emulsions, providing finely dispersed water-based silicone emulsions where the particle size is in the nanometer range. The emulsions in water can further include other components including for example alcohols, such as 2-butoxyethanol, or glycol ethers, such as for example, diethyleneglycol monobutyl ether, ethylene glycol monohexyl ether.

An exemplary polydimethylsiloxane (PDMS) or an emulsion thereof is a silicone having an average molecular weight, as measured by viscosity, of from 5,000 cst to 5,000,000 cst, or from 7,500 cst to 1,000,000 cst or even from 10,000 cst to 600,000 cst.

### Urethane-Based Hydrophobic Agents

The urethane-based hydrophobic agents that can be included as a non-fluorocarbon component can include urethane polymer dispersions including those available under the tradename Pulcra TEC F1. Additional examples of urethane-based hydrophobic agents include polyurethanes with fatty hydrocarbon chains, including chain lengths from C2-C24, including those that are cross-linkable polymers.

### Deposition Aid

The non-fluorocarbon treatment compositions comprise a deposition aid. As referred to herein deposition aids enhance the wetting and the enhance the resulting deposited barrier from the non-fluorocarbon treatment component. In embodiments the deposition aid is a nonionic wetting surfactant. Nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties.

Exemplary nonionic surfactants for the deposition aid in the non-fluorocarbon treatment compositions include alcohol ethoxylates, Guerbet alcohol ethoxylates, alcohol alkoxylates, EO/PO block copolymers, and fatty alcohol polyglycol ethers. An exemplary fatty alcohol ethoxylate is commercially-available as Fluowet UD. An exemplary Guerbet alcohol ethoxylate according to the formula R⁶—(OC₂H₄)ₘ—OH, wherein R⁶ is a branched C₉ to C₂₀ alkyl group, and m is from 2 to 10, preferably 2 to 6 is commercially-available as Lutensol XP. An exemplary alcohol alkoxylate having an alcohol chain length of about C₈-C₁₂ is commercially-available as Plurafac SLF-180. An exemplary EO/PO block copolymer is commercially-available as Pluronic 25-R2.

Useful nonionic surfactants include:

(1) Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available from BASF Corp. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-functional block copolymers derived from the sequential addition of propylene oxide and ethylene oxide to ethylenediamine. The molecular weight of the propylene oxide hydrotype ranges from about 500 to about 7,000; and the hydrophile, ethylene oxide, is added to constitute from about 10% by weight to about 80% by weight of the molecule.

Some examples of polyoxyethylene-polyoxypropylene block copolymers include those having the following formulae:

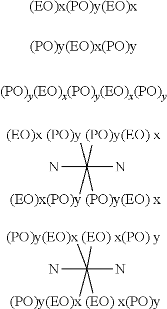

wherein EO represents an ethylene oxide group, PO represents a propylene oxide group, and x and y reflect the average molecular proportion of each alkylene oxide monomer in the overall block copolymer composition. In some embodiments, x is in the range of about 10 to about 130, y is in the range of about 15 to about 70, and x plus y is in the range of about 25 to about 200. It should be understood that each x and y in a molecule can be different.

(2) Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

(3) Condensation products of one mole of a saturated or unsaturated, straight, or branched chain alcohol having from about 6 to about 24 carbon atoms with from about 3 to about 50 moles of ethylene oxide. The alcohol moiety can consist of mixtures of alcohols in the above delineated carbon range, or it can consist of an alcohol having a specific number of carbon atoms within this range. Examples of like commercial surfactant are available under the trade names Lutensol™, Dehydol™ manufactured by BASF, Neodol™ manufactured by Shell Chemical Co. and Alfonic™ manufactured by Vista Chemical Co. A further example of a suitable nonionic surfactant includes alcohol ethoxylates, particularly those of a linear, primary carbon alcohol. In a preferred embodiment, the nonionic surfactant includes a 5-9 mole ethoxylate of a linear primary 12-14 carbon alcohol. Suitable surfactants are commercially available under the trade name Surfonic®, for example Surfonic® L24-7.

(4) Condensation products of one mole of saturated or unsaturated, straight, or branched chain carboxylic acid having from about 8 to about 18 carbon atoms with from about 6 to about 50 moles of ethylene oxide. The acid moiety can consist of mixtures of acids in the above defined carbon atoms range, or it can consist of an acid having a specific number of carbon atoms within the range. Examples of commercial compounds of this chemistry are available on the market under the trade names Disponil or Agnique manufactured by BASF and Lipopeg™ manufactured by Lipo Chemicals, Inc.

(5) In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this disclosure for specialized embodiments, particularly indirect food additive applications. All of these ester moieties have one or more reactive hydrogen sites on their molecule which can undergo further acylation or ethylene oxide (alkoxide) addition to control the hydrophilicity of these substances.

(6) Further suitable nonionic surfactants include reverse Pluronics™ which are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

(7) The alkylphenoxypolyethoxyalkanols of U.S. Pat. No. 2,903,486 issued Sep. 8, 1959, to Brown et al. and represented by the formula

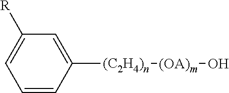

in which R is an alkyl group of 8 to 9 carbon atoms, A is an alkylene chain of 3 to 4 carbon atoms, n is an integer of 7 to 16, and m is an integer of 1 to 10.

(8) The polyalkylene glycol condensates of U.S. Pat. No. 3,048,548 issued Aug. 7, 1962, to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

(9) The nonionic surfactants disclosed in U.S. Pat. No. 3,382,178 issued May 7, 1968, to Lissant et al. having the general formula Z[(OR)ₙOH]_{z} wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

(10) The conjugated polyoxyalkylene compounds described in U.S. Pat. No. 2,677,700, issued May 4, 1954, to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

(11) The conjugated polyoxyalkylene compounds described in U.S. Pat. No. 2,674,619, issued Apr. 6, 1954 to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerin, glyceride, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

(12) Additional conjugated polyoxyalkylene surface-active agents which are advantageously used in the compositions of this disclosure correspond to the formula: P[(C₃H₆O)ₙ(C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

(13) Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a combination thereof; R₂ is a C₅-C₃₁ hydrocarbyl, which can be straight-chain; and Z is a polyhydroxy hydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

(14) The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

(15) The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

(16) Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

(17) Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)ₓH, where x is in the range of from 1 to 3.

(18) A useful class of nonionic surfactants include the class defined as alkoxylated amines or, most particularly, alcohol alkoxylated/aminated/alkoxylated surfactants. These nonionic surfactants may be at least in part represented by the general formulae: R²⁰—(PO)_{S}N-(EO)ₜH, R²⁰ (PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate. Suitable nonionic surfactants include alcohol alkoxylates, EO/PO block copolymers, alkylphenol alkoxylates, and the like.

Semi-Polar Nonionic Surfactants. The semi-polar type of nonionic surface-active agents are another class of nonionic surfactants.

Semi-polar nonionic surfactants useful herein also include the water-soluble sulfoxide compounds which have the structure:

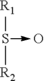

wherein the arrow is a conventional representation of a semi-polar bond; and R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms. Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyl dimethylamine oxide, nonyldimethylamine oxide, decyl dimethyl amine oxide, undecyldimethylamine oxide, dodecyldimethylamine oxide, iso-dodecyl dimethyl amine oxide, dodecyl dimethyl amine oxide (sold commercially as Barlox 12), tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

In some embodiments, the deposition aid is a nonionic surfactant deposition aid. In preferred embodiments, the nonionic surfactant deposition aid is an alcohol alkoxylate, such as an alcohol ethoxylate, Guerbet alcohol ethoxylate, EO/PO block copolymers, and/or fatty alcohol polyglycol ether. In an exemplary embodiment, nonionic surfactant deposition aids have one or more of the following characteristics: an HLB between about 11 and about 13; a carbon chain length between about C10-C16; a low surface tension (e.g. measured by a surface tension below about 28 dynes/cm at 0.1 wt-% solution); are fast wetting (e.g. measured by a Draves wetting time of about <10 seconds for 0.1 wt-% solution; and/or branched structure.

In some embodiments, the deposition aid is included in the composition at an amount of at least about 0.1 wt-% to about 20 wt-%, about 0.1 wt-% to about 10 wt-%, about 1 wt-% to about 10 wt-%, about 1 wt-% to about 9 wt-%, about 1 wt-% to about 8 wt-%, about 1 wt-% to about 7 wt-%, about 1 wt-% to about 6 wt-%, or about 1 wt-% to about 5 wt-%. In addition, without being limited according to the invention, all ranges recited are inclusive of the numbers defining the range and include each integer within the defined range.

### Water

The non-fluorocarbon treatment compositions comprise water. Various sources of water can be used, including for example softened water. In embodiments water makes up the remainder of the non-fluorocarbon treatment composition once the non-fluorocarbon treatment component, deposition aid and any additional functional ingredients to provide 100 wt-% of the composition. In some embodiments, water is included in the compositions at an amount of at least about 10 wt-% to about 70 wt-%, about 10 wt-% to about 60 wt-%, about 20 wt-% to about 60 wt-%, about 30 wt-% to about 60 wt-%, or about 40 wt-% to about 60 wt-%. In addition, without being limited according to the invention, all ranges recited are inclusive of the numbers defining the range and include each integer within the defined range.

### Additional Functional Ingredients

The components of the composition can further be combined with various functional components suitable for uses disclosed herein, including providing a non-fluorocarbon treatment composition for fluid repellency, including that applied in a finishing step of a washing cycle for laundry. In some embodiments, the compositions including the non-fluorocarbon treatment component, deposition aid and water make up a large amount, or even substantially all of the total weight of the compositions.

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in the particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the compositions may include optical additional deposition agents, preservatives, solubility modifiers, dispersants, stabilizing agents, builders/sequestrants/chelating agents, aesthetic enhancing agents including fragrances and/or dyes, additional rheology and/or solubility modifiers or thickeners, hydrotropes or couplers, buffers, solvents, and the like. These additional ingredients can be pre-formulated with the compositions or added to the use solution before, after, or substantially simultaneously with the addition of the compositions.

According to embodiments, the various additional functional ingredients may be provided in a composition in the amount from about 0 wt-% and about 40 wt-%, from about 0 wt-% and about 30 wt-%, from about 0 wt-% and about 20 wt-%, from about 0.01 wt-% and about 20 wt-%, from about 0.1 wt-% and about 20 wt-%, from about 1 wt-% and about 20 wt-%, from about 1 wt-% and about 10 wt-%, or from about 1 wt-% and about 8 wt-%. In addition, without being limited according to the invention, all ranges recited are inclusive of the numbers defining the range and include each integer within the defined range.

In an embodiment, a quaternary ammonium compound is included in the non-fluorocarbon treatment composition as a preservative. Quaternary ammonium compounds have the following general formula:

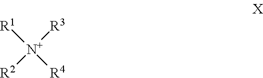

wherein R¹, R², R³, and R⁴ can each be C₁-C₂₄ aliphatic, normal, or branched saturated or unsaturated hydrocarbon groups, alkoxy groups (R—O—), polyalkoxy groups, benzyl groups, allyl groups, hydroxyalkyl groups (HOR—), and the like, and X is an anion, selected from halide, methyl sulphate or ethyl sulphate radicals. The quaternary ammonium compounds can include any anion or counter ion that allows the component to be used in a manner that imparts fabric-softening properties. Example counter ions include chloride, methyl sulfate, ethyl sulfate, and sulfate.

Example quaternary ammonium compounds have the following general formula:

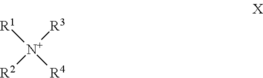

wherein R¹ and R² represent the same or different hydrocarbyl groups having from about 12 to about 24 carbon atoms, from about 12 to about 22 carbon atoms, more from about 14 to about 22 carbon atoms, or still more from about 14 to about 20 carbon atoms; R³ and R⁴ represent the same or different hydrocarbyl groups containing about 1 to about 4 carbon atoms; and X is any suitable anion, such as a halide. Preferred quaternary ammonium compounds have highly saturated carbon backbones (i.e., high degree of saturation of alkyl groups) of the hydrocarbyl groups. the quaternary ammonium compounds have two long R alkyl or alkenyl based chains (i.e., R¹ and R²) As referred to herein, “highly saturated” or a “high degree of saturation” with reference to the carbon backbones are represented by a low iodine value of the quaternary ammonium compounds, namely an iodine value equal to 15 or less. Exemplary quaternary ammonium compounds can include alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, or a combination thereof. For example, didecyl dimethyl ammonium chloride, dimethyl dioctyl ammonium chloride, C12-C16 alkyl dimethyl benzyl ammonium chloride, decyl dimethyl octyl ammonium chloride, are exemplary quaternary ammonium compounds for preservatives.

According to an embodiment, the quaternary ammonium compound may be provided in a composition in the amount from about 0 wt-% and about 10 wt-%, from about 0.01 wt-% and about 10 wt-%, from about 0.05 wt-% and about 5 wt-%, or from about 0.01 wt-% and about 1 wt-%. In addition, without being limited according to the invention, all ranges recited are inclusive of the numbers defining the range and include each integer within the defined range.

In an embodiment, a solvent is included in the non-fluorocarbon treatment composition. In embodiments the solvent is included in addition to water in the composition. Exemplary solvents include, but are not limited to organic solvents, such as simple alkyl alcohols (e.g., ethanol, isopropanol, n-propanol, benzyl alcohol), glycol ethers, glycerin derivatives, low volatility nonfluorinated organic solvents, diol solvents, siloxanes, other silicones, hydrocarbons, and the like. Exemplary organic solvents are C1-2 alcohols, glycols such as ethylene glycol and propylene glycol, dipropylene glycol or polyethylene glycols. In some embodiments, the solvent includes water and propylene glycol.

Polyols are also useful carriers, including glycerol, sorbitol, and the like. Suitable carriers include glycol ethers. Suitable glycol ethers include diethylene glycol n-butyl ether, diethylene glycol n-propyl ether, diethylene glycol ethyl ether, diethylene glycol methyl ether, diethylene glycol t-butyl ether, dipropylene glycol n-butyl ether, dipropylene glycol methyl ether, dipropylene glycol ethyl ether, dipropylene glycol propyl ether, dipropylene glycol tert-butyl ether, ethylene glycol butyl ether, ethylene glycol propyl ether, ethylene glycol ethyl ether, ethylene glycol methyl ether, ethylene glycol methyl ether acetate, propylene glycol n-butyl ether, propylene glycol ethyl ether, propylene glycol methyl ether, propylene glycol n-propyl ether, tripropylene glycol methyl ether and tripropylene glycol n-butyl ether, ethylene glycol phenyl ether, propylene glycol phenyl ether, and the like, or a combination thereof.

According to an embodiment, the additional solvent (i.e. a non-water solvent that is added in addition to the water) may be provided in a composition in the amount from about 0 wt-% and about 10 wt-%, from about 0.1 wt-% and about 10 wt-%, from about 1 wt-% and about 10 wt-%, or from about 1 wt-% and about 5 wt-%. In addition, without being limited according to the invention, all ranges recited are inclusive of the numbers defining the range and include each integer within the defined range.

### Treated Substrates

Treated substrates are also provided, wherein the substrate is treated with a layer or deposit of the non-fluorocarbon treatment composition to provide and/or maintain fluid repellancy. The substrates can include various surfaces including textiles and soft surfaces. As referred to herein various textiles and fabrics can be treated with the non-fluorocarbon treatment compositions, including those of various substances, fabric construction, fiber types, dyes, finishing agents, and the like. Exemplary textiles can include those in need of soil removal from the textile, including any item or article made from or including textile materials, woven fabrics, non-woven fabrics, and knitted fabrics. The laundry or textile can include natural or synthetic materials. In some embodiments, the laundry or textile is a synthetic material. In further embodiments the substrate is a cellulosic material, such as paper products, cardboard, and the like.

In any of the embodiments the substrate can have an initial or existing barrier treatment and have the non-fluorocarbon treatment composition applied thereto in order to provide and/or maintain fluid repellancy. According to an embodiment, the treated substrate becomes a fluid repellant surface after treatment with the non-fluorocarbon treatment composition.

The treated substrates provide a thin fluid repellant coating. The treated substrates have a shorter-term hydrophobic barrier for fluid repellancy than those barriers manufactured into a textile to provide a long term barrier by virtue of the crosslinking of chemistries into the textile. Instead, the treated substrates herein can be produced through a laundry process that is separate and distinct from a textile manufacturing process. The processes are distinct in that the treated substrates are formed during a washing cycle of a laundry process as opposed to textile manufacturing where a longer term cured barrier (e.g. impregnation of textiles with the hydrophobic barrier) is added onto the textile. Instead, through a distinct application of use a laundering or a bath (e.g. submerging) process imparts the fluid repellency onto a treated substrate surface. This is a beneficial distinction in methods of making the treated substrates as they afford ongoing fluid repellancy instead of textiles being discarded once an initial textile barrier is exhausted or removed.

According to an embodiment, the deposited non-fluorocarbon treatment composition remains upon the substrate surface for a period of time. For example, the non-fluorocarbon treatment composition remains on the surface until a subsequent wash cycle, and thereafter is replenished or maintained in the finishing step by applying additional non-fluorocarbon treatment composition to the substrate. Without being limited to a particular mechanism of action, the treated substrates do accumulate the non-fluorocarbon treatment composition over several application cycles and will achieve an equilibrium of the coating that is maintained upon each subsequent application.

### Methods of Use

The methods of applying a non-fluorocarbon treatment composition can include treating various substrates. In embodiments the methods are suitable for consumer and industrial laundering applications to impart repellency, namely industrial or institutional laundering applications. Various textiles and soft surface substrates are preferred for application in a laundry process in a finishing treatment on the textiles. As referred to herein various textiles and fabrics can be treated with the non-fluorocarbon treatment compositions, including those of various substances, fabric construction, fiber types, dyes, finishing agents, and the like. Exemplary textiles can include those in need of soil removal from the textile, including any item or article made from or including textile materials, woven fabrics, non-woven fabrics, and knitted fabrics. The laundry or textile can include natural or synthetic materials. In some embodiments, the laundry or textile is a cellulosic or synthetic material. In any of the embodiments the textile or other surface can have an initial or existing barrier treatment and have the non-fluorocarbon treatment composition applied thereto in order to provide and/or maintain fluid repellancy.

In an embodiment, the textile is from the healthcare industry or for a personal protective equipment (PPE) application. For example, the textile is a hospital gown, sheeting, towels, clothing article, gloves, hair coverings, surgical drapes or other textiles for covering patients or surfaces, or the like. In a further embodiment, the textile is a textile from the restaurant industry or hospitality industry. In a further embodiment, the textile is a tablecloth, napkin, uniform, apron, washcloth, dishcloth, mop, bedsheet, pillowcase, bedspread, towel, robe, or the like.

In embodiments according to the description herein for laundry applications of use, the non-fluorocarbon treatment composition is applied to the textile during the finishing phase. This is distinct from general detergency and/or washing steps of a laundry application, such as where a non-fluorocarbon treatment composition is combined with a detergent composition and/or the non-fluorocarbon treatment component is combined or dosed with a detergent composition. The application during a finishing step of a washing cycle provides an ongoing or repetitive laundry processing to provide maintenance dosing of the non-fluorocarbon treatment composition.

Beneficially the methods are employed using existing laundry processing equipment, including for example, institutional or industrial washing machines, including various types of commercial washer/extractor or tunnel washer, such as continuous batch tunnel washers or a washer/extractor, which have zones for carrying out each stage (e.g. pre-wash, wash, rinse, and finishing). The methods are suitable for various industrial and institutional processes and washing machines.

In conventional washing cycles, soils are removed from the textile occurs during the wash cycle, wherein the wash cycle comprises at least a pre-soak phase, a wash phase, a rinsing phase, a finishing phase, and an extraction phase. In some embodiments a washing cycle can also include an optional flush or pre-wash cycle. More particularly, in a typical washing process there is a pre-wash or pre-soak where the textiles are wetted, and a pre-soak composition is added (e.g. composition containing alkali and/or detergent to remove and/or loosen soils). The wash phase follows the pre-soak phase; a detergent and optionally alkali/builders are added to the wash tank to facilitate soil removal. In some cases, a bleach phase follows the wash phase in order to remove oxidizable stains, whiten and in some instances disinfect the textiles. Next, the rinsing phase(s) removes all suspended soils and a drain step removes the suspended soils and water from the wash tank and textiles.

In some cases, a finishing rinse or step is included. For example, a laundry sour is added in a souring or finishing phase to neutralize any residual alkalinity from the detergent composition and achieve an optimal linen pH or complete and post-treatment of the textiles needed. In many cases a fabric softener or other finishing chemical like a starch is also added in a finishing bath (or also referred to as the finishing step). Such finishing steps often include fabric softeners to enhance linen fell, starch to enhance linen stiffness, coatings to provide additional properties (e.g. flame retardancy, anti-wrinkle, antibacterial, etc.). Finally, the extraction phase removes as much water from the wash tank and textiles as possible. Further drying steps can follow before ironing, folding, etc. of the textiles.

So as not to be limited to the methods of a textile washing method within which the non-fluorocarbon treatment compositions can be employed, it is to be understood by skilled artisans that various modifications to this general washing process can be made. For example, a wash cycle may have two rinse and extraction phases, i.e., a rinse cycle, an intermediate-extract cycle, a final rinse cycle, and a final extraction cycle. After the wash cycle is complete, the resulting wastewater is typically removed and discarded.

In embodiments, the non-fluorocarbon treatment composition is added after the pre-wash, pre-soak, wash step, and/or bleach step. The non-fluorocarbon treatment composition is added after any wash cycle step where any detergent and/or souring chemistry is added to the wash tank and/or to the textiles.

In further embodiments, the non-fluorocarbon treatment composition is applied to the textile separate from other finishing components in the finishing bath, such as fabric softener or other finishing chemical like a starch. For example, after the rinsing step a laundry sour provides a desired pH and then the non-fluorocarbon treatment composition is applied in a finishing bath in what is referred to as a finishing step. In an embodiment the laundry sour and the non-fluorocarbon treatment composition can occur in the same bath. Either preceding or following this finishing step can be additional finishing steps such as fabric softener or other finishing chemical like a starch. Thereafter, the only remaining step in a laundry cycle will be the drying step, where beneficially the drying contributes to setting the coating on the surface of the textiles.

Contacting can comprise any of numerous methods for applying a liquid, such as pumping the composition for further use or dilution of a concentrate, immersing the object in the composition, foam or gel treating the object with the composition, or a combination thereof. Without being limited to the contacting according to the disclosure, a concentrate or use liquid composition can be applied to or brought into contact with the substrate in need of treatment for aqueous repellency by any conventional method or apparatus for applying a liquid composition to an object. For example, the surface can be wiped with, sprayed with, foamed on, or immersed in the liquid compositions, or use liquid compositions made from the concentrated liquid compositions. The liquid compositions can be sprayed, foamed, or wiped onto a surface; the compound can be caused to flow over the surface, or the surface can be dipped into the compound. Contacting can be manual or by machine. In preferred embodiments the substrate is contacted with the non-fluorocarbon treatment composition in a wash wheel of a laundry wash cycle.

According to an embodiment, the substrate such as a textile is treated in the finishing bath with between about 1,000 ppm to about 10,000 ppm of the non-fluorocarbon treatment composition (concentration of the overall product in the finishing bath). In textile laundry applications, the non-fluorocarbon treatment composition is added to the finishing step of the wash cycle at an amount between about 4 to about 32 fluid ounces per 100-pounds of textile to about 8 to about 32 fluid ounces per 100-pounds of textile. As referred to herein, the textile refers to both new and old textiles, such as hospital gowns.

According to an embodiment, the substrate such as a textile is contacted with the non-fluorocarbon treatment composition at a use or concentrate solution pH between about 4 to about 8, or preferably between about 4.5 to about 7.5.

According to a further embodiment, the substrate such as a textile is contacted with the non-fluorocarbon treatment composition at a temperature from about 80° F. to about 140° F.

In an embodiment, the treatment with the non-fluorocarbon treatment composition is for a sufficient amount of time to impart a barrier layer or deposit on the substrate, such as the textile, to provide the fluid repellency. The treating of the substrate with the non-fluorocarbon treatment composition provides a contact time of from about 60 seconds to about 15 minutes for the substrate with the non-fluorocarbon treatment composition. In embodiments, the contact time is from about 3 minute to 12 minutes, 3 minutes to 10 minutes, 3 minutes to 8 minutes, or about 6 minutes to about 8 minutes, inclusive of all integers within this range. In another aspect the finishing step of the washing process may last as long as several hours. Alternatively in non-washing applications, a substrate contacting step with the non-fluorocarbon treatment composition can be a soaking step. Beneficially, the methods of contacting with the non-fluorocarbon treatment compositions (laundry applications and non-washing applications) do not require repeating or multiple finishing steps.

In other embodiments non-textile surfaces can also be treated with the non-fluorocarbon treatment composition. For example, various cellulosic materials can be treated with the non-fluorocarbon treatment composition. For example, cellulosic materials in need of water repellency are preferred substrates. Examples of such cellulosic materials includes for example, packaging materials such as delivery or packing materials for food products. In such applications the substrates can have the non-fluorocarbon treatment composition applied with or independent from any washing steps.

Methods of use for cellulosic materials can vary in the time and process conditions for contacting the non-fluorocarbon treatment composition. For example, the compositions may be applied via spray nozzle, rather than soaking. In alternative embodiments a soaking application may be used.

Beneficially, the methods of using the non-fluorocarbon treatment composition provide at least substantially similar repellency to a fluorinated treatment composition on the substrate. The methods provide improved fluid repellency, in particular water repellency (hydrophobic properties) which is unexpected for a non-fluorocarbon chemistry to provide. As a further benefit the methods are free of fluorocarbon-containing chemistries, including perfluoroalkyl substances including perfluorooctyl acid. There is a significant benefit to providing a non-fluorocarbon composition and methods. Approaches that use any fluorocarbons, even those that are partially fluorinated polymers (e.g. polymer synthesized using alkyl chains excluding the octyl type in PFOA) are discarded in a laundering process and enter the water supply, or require further water treatment or remediation to remove the fluorinated materials (PFAS, PFOA or the like) pursuant to wastewater regulations. The compositions and methods of using the non-fluorocarbon treatment compositions described herein do not require further water treatment or remediation.

The present disclosure is further defined by the following numbered paragraphs:

A non-fluorocarbon treatment composition comprising: a non-fluorocarbon treatment component comprising at least one of a paraffin-based hydrophobic agent, a polydimethylsiloxane, or urethane-based hydrophobic agent; a nonionic surfactant deposition aid, and water, wherein the composition is an aqueous dispersion or emulsion.

The composition of paragraph 1, wherein the non-fluorocarbon treatment component is a paraffin-based hydrophobic agent comprising a dispersions of paraffin waxes, and preferably has a melting point between about 50-100° C.

The composition of paragraph 1, wherein the non-fluorocarbon treatment component is a polydimethylsiloxane that is a silicone polymer without any amino groups of functionality.

The composition of paragraph 1, wherein the non-fluorocarbon treatment component is a urethane-based hydrophobic agent comprising a polyurethane with fatty hydrocarbon chains.

The composition of any one of paragraphs 1-4, wherein the non-fluorocarbon treatment component comprises from about 10 wt-% to about 70 wt-%, from about 10 wt-% to about 60 wt-%, or from about 10 wt-% to about 50 wt-% of the composition, or from about 5% actives to about 15% actives in the composition.

The composition of any one of paragraphs 1-5, wherein the nonionic surfactant deposition aid is an alcohol ethoxylate, Guerbet alcohol ethoxylate, EO/PO block copolymers, or fatty alcohol polyglycol ether.

The composition of any one of paragraphs 1-6, wherein the nonionic surfactant deposition aid comprises from about 0.1 wt-% to about 20 wt-%, from about 0.1 wt-% to about 10 wt-%, or from about 1 wt-% to about 10 wt-% of the composition.

The composition of any one of paragraphs 1-7, further comprising at least one additional functional ingredient comprising an additional deposition agent, preservative, solubility modifier, dispersant, stabilizing agent, builder, aesthetic enhancing agent, rheology and/or solubility modifier, solvent, or combination thereof.

The composition of paragraph 8, wherein the additional functional ingredient comprises a preservative comprising from about 0.01 wt-% to about 1 wt-% of the composition and/or an additional solvent comprising from about 1 wt-% to about 10 wt-% of the composition.

A treated substrate comprising: a substrate and a non-fluorocarbon treatment composition according to any one of paragraphs 1-9 deposited thereon the substrate, wherein the treated substrate is a fluid repellent surface.

The composition of paragraph 10, wherein the substrate is a synthetic substrate or a cellulosic material.

A method of using a non-fluorocarbon treatment composition to impart fluid repellency to a substrate comprising: applying the non-fluorocarbon treatment composition according to any one of paragraphs 1-9 to a substrate, and imparting fluid repellency to the substrate.

The method of paragraph 12, wherein the applying of the non-fluorocarbon treatment composition is in a finishing step of a washing cycle for textile substrates.

The method of paragraph 13, wherein the washing cycle comprises a pre-soak phase, a wash phase, a rinsing phase, a finishing phase, and an extraction phase.

The method of paragraph 13, wherein the non-fluorocarbon treatment composition is added in a finishing step separate from starches, fabric softeners and/or other finishing step components.

The method of any one of paragraphs 13-15, wherein the washing cycle is in a washing machine, and wherein the washing machine is an institutional or industrial washing machine (e.g. commercial washer/extractor or tunnel washer).

The method of any one of paragraphs 12-16, wherein the non-fluorocarbon treatment composition is in contact with the substrate for about 3 minutes to about 12 minutes.

The method of any one of paragraphs 12-17, wherein about 1,000 ppm to about 10,000 ppm of the non-fluorocarbon treatment composition is applied, or the non-fluorocarbon treatment composition is applied to a textile in a washing cycle at between about 4 and about 32 fluid ounces per 100-pounds of textile.

The method of any one of paragraphs 12-18, wherein the non-fluorocarbon treatment composition is applied at a use or concentrate solution pH between about 4.5 and 7.5.

The method of any one of paragraphs 12-19, wherein the non-fluorocarbon treatment composition is applied at a temperature range between about 80° F. and about 140° F. in the finishing step.

The method of any one of paragraphs 18-20, wherein a drying cycle follows the application of the non-fluorocarbon treatment composition in the washing cycle, and wherein the drying cycle has a temperature range between about 140° F. and about 240° F.

The method of any one of paragraphs 12-21, wherein the methods are free of fluorocarbons and does not discard into wastewater from a laundry process fluorocarbons.

The method of paragraph 22, wherein the methods are free of perfluoroalkyl substances including perfluorooctyl acid.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

The following materials described in Table 2 were evaluated in the Examples:

TABLE 2
Description
hydrocarbon urethane polymer A
hydrocarbon urethane polymer B
paraffin and polymer dispersion A
paraffin and polymer dispersion B
nonionic surfactant
Modified polydimethyl siloxane emulsion
Polydimethyl siloxane diquat
Paraffin Wax based emulsion
Cationic polymer dispersion
Sucrose ester of fatty acid + latex polymer
Sucrose ester of fatty acid
Acrylic polymer with additives
urethane polymer dispersion with additives
Modified polydimethylsiloxane A
Modified polydimethylsiloxane B
Polysiloxane + silane terminated polyether

### Example 1

Tergotometer screening was used to compare non-fluorocarbon chemistries following AATCC 193 Test Method for Aqueous Liquid Repellency: Water/Alcohol Solution Resistance. The testing determines efficacy of protective finishes on all types of fabrics by evaluating the fabric's resistance to wetting by series of water/alcohol solutions of different surface tensions. Drops of test liquids are placed on fabric surfaces and observed for wetting, wicking and contact angle. The test is used to represent aqueous based materials or in some cases fluids that has water and other liquids such as blood or plasma in healthcare.

All chemistries listed below in Table 3 were tested based on equal actives. Ratings were assigned based on pass/fail criteria with different water/IPA mixtures according to AATCC 193 including the following conditions for the test specimens: minimum of 4 hours at 21±2° C. (70±4° F.) and 65±5% RH prior to testing. Each specimen is placed flat on a white textile blotting paper on a smooth, horizonal surface. Beginning with the lowest-numbered test liquid small drops (approximately 5 mm in diameter or 0.005 mL volume) are placed on the test specimen in three locations approximately 4.0 cm apart. The drops are observed for approximately 10 seconds from approximately a 45° angle. If no penetration or wetting of the fabric and the liquid-fabric interface and no wicking around the drops occur, the next higher-numbered test liquid is added to the test specimen. The procedure is continued until one of the test liquids shows obvious wetting or wicking of the fabric under or around the drop within the approximately 10 seconds of observation.

The evaluated fabrics included a Medline uncoated gown (55% cotton/45% polyester blend with no pretreatment to provide repellency), coated clean room gown (98% polyester/2% cotton textile with a water-repelling coating), and uncoated woven polyester textile (100% Polyester with no pretreatment to provide repellency).

The aqueous repellency grade is the highest numbered test liquid that does not wet the fabric surface according to the following grading scale: Rating scale: 9 (Pass at 70% IPA), 8 (Pass at 60% IPA), 7 (Pass at 50% IPA), 6 (Pass at 40% IPA), 5 (Pass at 30% IPA), 4 (Pass at 20% IPA), 3 (Pass at 10% IPA), 2 (Pass at 1% IPA), 1 (Pass at 100% DI water), 0 (Fails at 100% DI water). The test compositions refer to vol:vol ratio of DI water to isopropyl alcohol (IPA). The higher the scale number or grade for the aqueous repellency the more repellent the surface, and the better resistance to staining by aqueous materials, especially liquid aqueous substances.

TABLE 3

| | Average of Rating | | | |
|---|---|---|---|---|
| | | Coated | | |
| | | Clean | Un- | |
| | Uncoated | Room | coated | |
| Chemistry | Gown | Gown | Textile | Overall |
| hydrocarbon urethane | 2.92 | 3.50 | 3.83 | 3.42 |
| polymer A | | | | |
| hydrocarbon urethane | 3.92 | 3.83 | 3.92 | 3.89 |
| polymer B | | | | |
| paraffin and polymer | 3.00 | 4.00 | 3.67 | 3.56 |
| dispersion A | | | | |
| paraffin and polymer | 3.92 | 3.42 | 4.00 | 3.78 |
| dispersion B | | | | |
| paraffin and polymer | 4.00 | 4.17 | 4.50 | 4.22 |
| dispersion B + nonionic | | | | |
| surfactant | | | | |
| Modified polydimethyl | 2.83 | 4.25 | 3.67 | 3.58 |
| siloxane emulsion | | | | |
| Polydimethyl siloxane diquat | 2.08 | 3.00 | 3.00 | 2.69 |
| Paraffin Wax based emulsion | 3.75 | 3.92 | 3.83 | 3.83 |
| Cationic polymer dispersion | 4.17 | 4.17 | 4.17 | 4.17 |
| Sucrose ester of fatty acid + | 2.75 | 2.67 | 2.17 | 2.53 |
| latex polymer | | | | |
| Sucrose ester of fatty acid | 3.83 | 2.67 | 3.33 | 3.28 |
| Acrylic polymer with | 3.42 | 4.17 | 3.83 | 3.81 |
| additives | | | | |
| urethane polymer dispersion | 3.75 | 4.00 | 4.00 | 3.92 |
| with additives | | | | |
| Modified | 4.33 | 4.92 | 4.42 | 4.56 |
| polydimethylsiloxane A | | | | |
| Modified | 4.58 | 5.00 | 4.75 | 4.78 |
| polydimethylsiloxane B | | | | |
| Polysiloxane + silane | 3.00 | 3.75 | 2.00 | 2.92 |
| terminated polyether | | | | |

The results shown in Table 3 highlight several of the chemistries with best repellency performance. Notably the paraffin and polymer dispersion B repellency was enhanced with the inclusion of a wetting agent.

### Example 2

Additional testing of the best performing non-fluorocarbon laundry treatment composition evaluated in Example 1 were compared to a fluorinated (or fluorocarbon-containing) commercial control (Commercial Control) using washwheel testing on various additional textiles as set forth in Table 4. The test method involved washing the textiles for 10 cycles in a commercial 35 lb. capacity washer/extractor, and using a healthcare linen wash process utilizing, detergent, alkali, and finishing treatment. The grading was the same as what was used in Example 1. The evaluated textiles include an untreated gown and woven polyester textile, as well as Levels I-III gowns (which are pre-treated with a barrier property on the textile, e.g., hospital gowns pretreated to repel bodily fluids for safety of the wearer), as well as untreated gowns from the field (i.e. unknown number of wash cycles and did not have fluid repellent chemistry in the field as a treatment).

TABLE 4

| | | Textile | | | | | | |
|---|---|---|---|---|---|---|---|---|
| | | | | | Level | | Uncoated | |
| | | | Coated | Coated | II | | Gown | |
| | | | Level | Level | Gown— | Woven | (used | |
| | | Uncoated | I | II | layered | Polyester | from | |
| Chemistry | Cycles | Gown | Gown | Gown | part | Textile | field) | Overall |
| Commercial | 1 | 2.50 | 4.50 | 6.00 | 5.00 | 3.00 | 3.50 | 3.80 |
| Control | 3 | 2.00 | 5.00 | 5.00 | 5.00 | 3.00 | 3.50 | 3.70 |
| | 5 | 3.00 | 5.00 | 5.00 | 5.00 | 4.00 | 3.50 | 4.10 |
| | 10 | 4.00 | 5.00 | 5.00 | 5.00 | 4.00 | 4.00 | 4.40 |
| | Avg | 2.88 | 4.88 | 5.25 | 5.00 | 3.50 | 3.63 | 4.00 |
| Paraffin and | 1 | 2.00 | 6.00 | 5.00 | 6.00 | 2.50 | 4.00 | 4.00 |
| polymer | 3 | 2.50 | 6.00 | 5.00 | 6.00 | 3.00 | 4.50 | 4.30 |
| dispersion | 5 | 3.00 | 6.00 | 6.00 | 6.00 | 3.00 | 4.00 | 4.40 |
| B + nonionic | 10 | 3.00 | 6.00 | 6.00 | 6.00 | 3.00 | 4.00 | 4.40 |
| surfactant | Avg | 2.63 | 6.00 | 5.50 | 6.00 | 2.88 | 4.13 | 4.28 |
| Urethane | 1 | 1.00 | 6.00 | 7.00 | 7.00 | 1.00 | 4.00 | 3.80 |
| polymer | 3 | 2.00 | 6.00 | 6.00 | 6.00 | 2.50 | 3.50 | 4.00 |
| dispersion | 5 | 3.00 | 6.00 | 5.00 | 6.00 | 4.00 | 3.50 | 4.40 |
| with | 10 | 3.00 | 5.00 | 4.00 | 5.00 | 3.00 | 3.00 | 3.70 |
| additives | Avg | 2.25 | 5.75 | 5.50 | 6.00 | 2.63 | 3.50 | 3.98 |
| Modified | 1 | 1.00 | 6.00 | 7.00 | 8.00 | 1.00 | 4.00 | 3.90 |
| polydimethyl- | 3 | 3.00 | 5.50 | 5.00 | 7.00 | 3.00 | 4.00 | 4.30 |
| siloxane B | 5 | 3.00 | 5.00 | 4.00 | 7.00 | 3.00 | 4.00 | 4.10 |
| | 10 | 2.00 | 4.00 | 4.00 | 6.00 | 3.00 | | 3.50 |
| | Avg | 2.25 | 5.13 | 5.00 | 7.00 | 2.50 | 4.00 | 3.97 |

The results in Table 4 show that the non-fluorocarbon laundry treatment compositions (each of the (1) paraffin and polymer dispersion B+nonionic surfactant, (2) urethane polymer dispersion with additives, and (3) modified polydimethylsiloxane) outperforms the fluorinated Commercial Control on various textiles including barrier textiles, while also providing benefits on non-barrier textiles. Although the Commercial Control has improved grading over the non-fluorocarbon laundry treatment compositions on the untreated textiles (blue gown and napkin), the use of the non-fluorocarbon laundry treatment composition in comparison to a negative control (which would have a grading of 0) would illustrate benefit. The results also showed that the top performing non-fluorocarbon laundry treatment compositions identified in the tergotometer screening tests in Example 1 were all able to show comparable repellency performance to the inline fluorinated Commercial Control.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof

What is claimed is:

1. A method of using a non-fluorocarbon treatment composition to impart fluid repellency to a substrate comprising:
applying a non-fluorocarbon treatment composition to a substrate in a finishing step of a washing cycle for textile substrates, wherein the non-fluorocarbon treatment composition comprises: a non-fluorocarbon treatment component comprising at least one of a paraffin-based hydrophobic agent, a polydimethylsiloxane, or urethane-based hydrophobic agent; a nonionic surfactant deposition aid; and water; wherein the non-fluorocarbon treatment composition is an aqueous dispersion or emulsion; and
imparting fluid repellency to the substrate.

2. The method of claim 1, wherein the washing cycle comprises a pre-soak phase, a wash phase, a rinsing phase, a finishing phase, and an extraction phase.

3. The method of claim 1, wherein the non-fluorocarbon treatment composition is added in the finishing step separate from starches, fabric softeners and/or other finishing step components.

4. The method of claim 1, wherein the washing cycle is in a washing machine, and wherein the washing machine is an institutional or industrial washing machine.

5. The method of claim 1, wherein the non-fluorocarbon treatment composition is in contact with the substrate for about 3 minutes to about 12 minutes.

6. The method of claim 1, wherein about 1,000 ppm to about 10,000 ppm of the non-fluorocarbon treatment composition is applied, or wherein the non-fluorocarbon treatment composition is applied to a textile in a washing cycle at between about 4 and about 32 fluid ounces per 100-pounds of textile.

7. The method of claim 1, wherein the non-fluorocarbon treatment composition is applied at a use or concentrate solution pH between about 4.5 and 7.5.

8. The method of claim 1, wherein the non-fluorocarbon treatment composition is applied at a temperature range between about 80° F. and about 140° F.

9. The method of claim 1, wherein a drying cycle follows the application of the non-fluorocarbon treatment composition, and wherein the drying cycle has a temperature range between about 140° F. and about 240° F.

10. The method of claim 1, wherein the methods are free of fluorocarbons.

11. The method of claim 10, wherein the methods are free of perfluoroalkyl substances including perfluorooctyl acid.

12. The method of claim 1, wherein the non-fluorocarbon treatment composition comprises a paraffin-based hydrophobic agent comprising a dispersion of paraffin waxes, and wherein the paraffin-based hydrophobic agent comprises from about 10 wt-% to about 70 wt-% of the composition, or from about 5% actives to about 15% actives in the composition.

13. The method of claim 1, wherein the nonionic surfactant deposition aid is an alcohol alkoxylate, Guerbet alcohol ethoxylate, EO/PO block copolymers, or fatty alcohol polyglycol ether, and wherein the nonionic surfactant deposition aid comprises from about from about 0.1 wt-% to about 20 wt-% of the composition.

14. The method of claim 1, wherein the non-fluorocarbon treatment composition further comprises at least one additional functional ingredient comprising an additional deposition agent, preservative, solubility modifier, dispersant, stabilizing agent, builder, aesthetic enhancing agent, rheology and/or solubility modifier, solvent, or combination thereof.

15. The method of claim 14, wherein the additional functional ingredient comprises a preservative comprising from about 0.01 wt-% to about 1 wt-% of the composition and/or an additional solvent comprising from about 1 wt-% to about 10 wt-% of the composition.

16. A non-fluorocarbon treatment composition comprising:
a non-fluorocarbon treatment component comprising at least one of a paraffin-based hydrophobic agent, a polydimethylsiloxane, or urethane-based hydrophobic agent;
a nonionic surfactant deposition aid, and
water, wherein the composition is an aqueous dispersion or emulsion.

17. The composition of claim 16, wherein the non-fluorocarbon treatment component is a paraffin-based hydrophobic agent comprising a dispersions of paraffin waxes, and preferably has a melting point between about 50-100° C., or wherein the non-fluorocarbon treatment component is a polydimethylsiloxane that is a silicone polymer without any amino groups of functionality, or wherein the non-fluorocarbon treatment component is a urethane-based hydrophobic agent comprising a polyurethane with fatty hydrocarbon chains, and wherein the non-fluorocarbon treatment component comprises from about 10 wt-% to about 70 wt-% of the composition, or from about 5% actives to about 15% actives in the composition.

18. The composition of claim 16, wherein the nonionic surfactant deposition aid is an alcohol alkoxylate, Guerbet alcohol ethoxylate, EO/PO block copolymers, or fatty alcohol polyglycol ether, and wherein the nonionic surfactant deposition aid comprises from about 0.1 wt-% to about 20 wt-% of the composition.

19. The composition of claim 16, further comprising a preservative comprising from about 0.01 wt-% to about 1 wt-% of the composition, and/or an additional solvent comprising from about 1 wt-% to about 10 wt-% of the composition.

20. A treated substrate comprising:
a substrate and a non-fluorocarbon treatment composition according to claim 16 deposited thereon the substrate,
wherein the treated substrate is a fluid repellent surface, and
wherein the substrate is a synthetic substrate or a cellulosic material.
